(19) United States
(12) Patent Application Publication
(10) Pub. No.: US 2020/0048591 A1
(43) Pub. Date: Feb. 13, 2020

(54) ULTRASONIC BEER BUBBLING CONTAINER

(71) Applicant: SHENZHEN TANGSON HOUSEWARE CO., LTD, SHENZHEN (CN)

(72) Inventor: YUNXIAO ZHAO, SHENZHEN (CN)

(21) Appl. No.: 16/293,680

(22) Filed: Mar. 6, 2019

(30) Foreign Application Priority Data
Aug. 9, 2018 (CN) 2018212804055

(51) Int. Cl. C12C 11/11; B01F 3/04; B01F 11/02

(52) U.S. Cl. CPC C12C 11/11; B01F 3/04446; B01F 2215/0068; B01F 11/0258; B01F 3/04978

(57) ABSTRACT

The present application relates to ultrasonic technology, and discloses an ultrasonic beer bubbling container with a good bubble foaming effect and less energy loss. The ultrasonic beer bubbling container comprises a cup body for containing beer and a base provided on the bottom of the cup body. The cup body and the base are separable; an ultrasonic vibrator is arranged in the base, and a through-hole is formed on the bottom of the cup body; wherein a part of the ultrasonic vibrator goes through the through-hole and extends to the cup body, thus to produce ultrasound and directly vibrate the beer so as to foam the beer.

### BACKGROUND OF INVENTION

### 1. Field of Invention

The present disclosure relates to the field of ultrasonic technology, and more particularly relates to an ultrasonic beer bubbling container.

### 2. Description of Prior Art

It is a common combination that an ultrasonic foaming machine and an beer container, as two separate devices, are used together for foaming the beer in a. beer glass. An ultrasonic generator needs liquid as media, the ultrasound generated by the ultrasonic generator is transmitted into the beer through the cup wall and thus foams the beer. Traditionally, when using this combination, user needed to put the ultrasonic generator into the beer cup body so the ultrasonic generator cannot be moved freely. Besides, the proceeding of adding liquid media is complicated, thus leading to a poor experience.

Therefore, the prior art provides a cup body in a whole unit, which is formed by combining the ultrasonic generator with the beer container, and it overcomes the problem of the complicated proceeding when user adding liquid media. However, there is a gap on the joint between the ultrasonic generator and the beer cup body; when the ultrasonic generator is used to vibrate the liquid media in the cup body the energy loss is serious and the bubble foaming effect is not sufficient.

### SUMMARY OF INVENTION

The technical problem of the present disclosure is to provide an ultrasonic beer bubbling container with a good bubble foaming effect and less energy loss.
The technical solution of the present disclosure used to solve the technical problem is to provide an ultrasonic beer bubbling container comprising a cup body for containing beer and a base provided on the bottom of the cup body, the cup body and the base being configured as separable;

an ultrasonic vibrator being arranged in the base, a through-hole being formed on the bottom of the cup body; a part of the ultrasonic vibrator being configured as going through the through-hole and extending into the cup body, thus producing ultrasound for directly vibrating the beer to foam the beer.

Preferably, a seal ring is provided within the through-hole, which seal ring is arranged on the contacting face of the ultrasonic vibrator and the through-hole, and the seal ring is used for sealing the gap between the ultrasonic vibrator and the through-hole.

Preferably an internal thread is formed on the inner side of the bottom of the cup body, and an external thread is formed on the outer side of the base; the internal thread is screwed into the external thread so that the cup body and the base form an entirety.

Preferably, an upper hollow chamber is formed in the base and a spacer is provided in the upper hollow chamber; a circuit board is arranged on the bottom of the spacer, and the circuit board is connected to the ultrasonic vibrator.

Preferably the base further comprises a lower hollow chamber, in which a storage battery is arranged; and the storage battery is connected to the circuit board.

Preferably, a bottom cowling plate is arranged on the bottom of the base, and the bottom covering plate is used for covering the lower hollow chamber.

Preferably, a touch switch is provided on one side of the base, and the touch switch is used for controlling the ultrasonic vibrator.

Preferably, a charging interface is formed on the other side of the base, and the charging interface is connected to the circuit board.

Preferably, the cup body is made of glass material and the base is made of plastic material.

According to the ultrasonic beer bubbling container, of the present invention, the cup body is detachably combined together with the base. A through-hole is formed at the bottom of the cup body for fixing the ultrasonic vibrator. A part of the ultrasonic vibrator extends into the cup body through the through-hole so as to achieve that the ultrasonic vibrator directly contacts with beer and foams the beer, which can effectively improve the bubble foaming effect of the container. Compared with the previous foaming technology, the present application solves the problem of energy loss in the process of the ultrasonic generator transmitting energy, of which can effectively improve the drinking taste of beer.

### BRIEF DESCRIPTION OF DRAWINGS

The present invention is further illustrated in the following by combining the drawings with the embodiments, in the drawings:

FIG. 1 is a schematic perspective view of the ultrasonic beer bubbling container.

FIG. 2 is a schematic cross-sectional structure view of the ultrasonic beer bubbling container.

FIG. 3 is a schematic cross-sectional structure view of the base.

### DETAILED DESCRIPTION OF PREFERRED EMBODIMENTS

In order to have a clear understanding of the technical features, the purpose and the effect of the present application, the specific embodiment of the present application is described in detail by referring to the drawings.

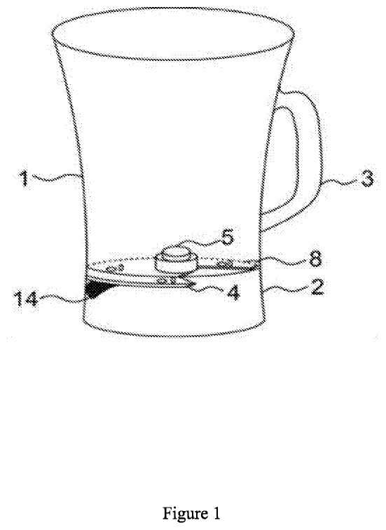

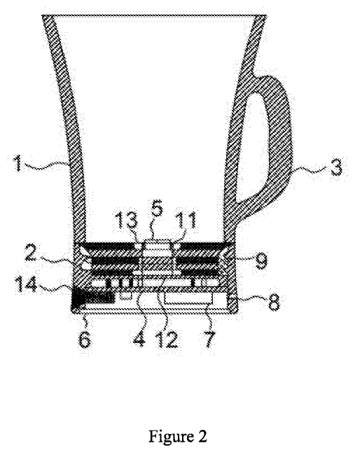

FIG. 1 is a schematic perspective view of the ultrasonic beer bubbling container of the present application, and FIG. 2 is the schematic cross-sectional structure view of the ultrasonic beer bubbling container of the present application. As shown in FIG. 1 and FIG. 2, the container comprises a cup body 1, a base 2 and a cup handle 3. The cup body 1 is detachably configured on the base 2. Furthermore, an ultrasonic vibrator 5 is arranged in the base 2.

The ultrasonic vibrator 5 is consists of an ultrasonic transducer and an ultrasonic amplitude transformer. Specifically, the ultrasonic transducer is a device which can convert the high-frequency electrical energy into the mechanical energy. The ultrasonic amplitude transformer is a passive device, which itself does not produce vibration but only receive and change the amplitude of the vibration inputted by the ultrasonic transducer, and transmit out later, thus to complete impedance transformation.

Specifically; a through-hole 11 is formed at the bottom of the cup body 1, which through-hole 11 is preferably a round hole. The inner diameter of the through-hole 11 is larger than the outer diameter of the ultrasonic vibrator 5. Specifically, a part of the ultrasonic vibrator 5 goes through the through-hole and extends into the cup body 1. The ultrasonic vibrator 5 contacts with the beer in the cup body 1 and produces ultrasound into the beer, the ultrasound vibrates together with the beer thus to produce bubbles. Therefore, energy loss during transmission can be reduced, beer foaming effect can be enhanced, and the taste of beer drinking can be improved.

Furthermore, a seal ring 13 is provided within the through-hole 11, which seal ring 13 is configured on the contacting face of the ultrasonic vibrator 5 and the through-hole 11. The seal ring 13 is used for sealing the gap between the ultrasonic vibrator 5 and the through-hole 11 so as to prevent the beer liquid infiltrating into the base 2 and causing a short circuit in the base 2. Thus the safety of the circuit can be effectively improved.

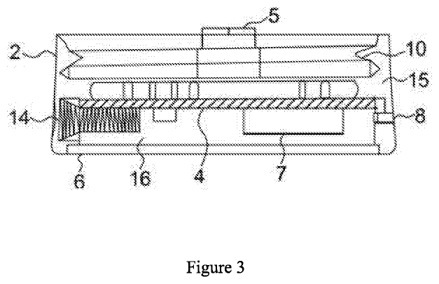

FIG. 3 is a schematic cross-sectional structure view of the base 2. As shown in FIG. 3, the internal thread 10 is formed on the inner side of the bottom of the cup body 1. As shown in FIG. 2, an external thread 9 is formed on the outer side of the base 2. The internal thread 10 of the inner side of the cup body 1 is screwed into the external thread 9 to form a whole ultrasonic beer bubbling container.

As shown in FIG. 3, a hollow chamber structure is formed in the inner of the base 2, and particularly formed as an upper hollow chamber 15 and a lower hollow chamber 16. A spacer 12 is provided within the upper hollow chamber 15 and a circuit board 4 is arranged on the bottom of the spacer 12. The circuit board 4 comprises integrated circuits and other peripheral circuits. A signal output end of the circuit board 4 is connected to the ultrasonic vibrator 5 and inputted the ultrasonic signal. The circuit board 4 provides a signal in a specific frequency (such as, above the frequency range of 20 KHz) to the ultrasonic transducer (belongs to the ultrasonic vibrator 5), and the signal could be a sinusoidal signal or an impulse signal. The special frequency is a working frequency of the ultrasonic transducer. After the ultrasonic transducer inputs its working frequency signal into the ultrasonic amplitude transformer (belongs to the ultrasonic vibrator 5), the ultrasonic amplitude transformer converts the inputted ultrasonic frequency into mechanical vibration. The ultrasonic amplitude transformer amplifies the particle displacement or velocity of the mechanical vibration, and then focuses the ultrasonic energy on a small area (the beer in the cup body 1), thus to produce bubbles in the beer at the bottom of the cup body 1.

Specifically, in the case of the seal ring 13 failing, the spacer 12 is used to prevent the liquid from infiltrating into the base 2 through the through-hole 11 and causing a short circuit in the circuit board 4, which will affect the ultrasonic vibrator 5 working.

Furthermore, a storage battery 7 is arranged in the lower hollow chamber 16, and the storage battery 7 is used for storing electric energy. When the container is cut off from electric supply, the storage battery 7 can supply power to the circuit board 4. Thus the ultrasonic vibrator 5 can produce high-frequency ultrasound wirelessly, by which the beer can produce bubbles without location limitation,

A touch switch 14 is arranged on one side of the cup body 1, which touch switch 14 is used to control the working or stopping of the ultrasonic vibrator 5.

A charging interface 8 is formed on the other side of the cup body which is jointly connected with the circuit board 4 and the battery 7.

Specifically, a bottom covering plate 6 is provided on the bottom of the base 2, which is used for covering the lower hollow 16 of the base 2.

More specifically, the cup body 1 is made of glass material which makes the status of beer bubbles in the cup body 1 visually observable. The base 2 is made of plastic material which has the advantages of good insulation, low thermal conductivity and good impact resistance. A cup handle 3 is formed at any side of the cup body 1, which is convenient for holding the cup.

The embodiment of the present disclosure is described by combining with the drawings in above; but the present application is not limit to the above specific embodiment. The above specific embodiment is only schematic rather than restrictive. The person skilled in the art under the enlightenment of the disclosure, without beyond the protected scope of the purpose and claims of the application, can still realise it in many other ways, all of these are belong to the scope of protection of the application.

What is claimed is:

1. An ultrasonic beer bubbling container comprising a cup body for containing beer and a base provided on the bottom of the cup body, the cup body and the base being configured as separable;
an ultrasonic vibrator being arranged in the base, a through-hole being formed on the bottom of the cup body; a part of the ultrasonic vibrator being configured as going through the through-hole and extending into the cup body, thus producing ultrasound for directly vibrating the beer to foam the beer.

2. The ultrasonic beer bubbling container according to claim 1, wherein a seal ring is provided within the through-hole, which seal ring is arranged on the contacting face of the ultrasonic oscillator and the through-hole, and used for sealing the gap between the ultrasonic vibrator and the through-hole.

3. The ultrasonic beer bubbling container according to claim 1, wherein an internal thread is formed on the inner side of the bottom of the cup body, and an external thread is formed on the outer side of the base; the internal thread is screwed into the external thread so that the cup body and the base form an entirety.

4. The ultrasonic beer bubbling container according to claim 1, wherein an upper hollow chamber is formed in the base and a spacer is provided in the upper hollow chamber; a circuit board is arranged on the bottom of the spacer, and the circuit board is connected to the ultrasonic vibrator.

5. The ultrasonic beer bubbling container according to claim 4, the base further comprises a lower hollow chamber, in which a storage battery is arranged; and the storage battery is connected to the circuit board.

6. The ultrasonic beer bubbling container according to claim 5, wherein a bottom covering plate is arranged on the bottom of the base, and the bottom covering plate is used for covering the lower hollow chamber.

7. The ultrasonic beer bubbling container according to claim 4, wherein a touch switch is provided on one side of the base, and the touch switch is used for controlling the ultrasonic vibrator.

8. The ultrasonic beer bubbling container according to claim 4, wherein a charging interface is formed on the other side of the base, and the charging interface is connected to the circuit board.

9. The ultrasonic beer bubbling container according to claim 1, wherein the cup body is made of glass material and the base is made of plastic material.
